(19) United States
(12) Patent Application Publication
(10) Pub. No.: US 2024/0177560 A1
(43) Pub. Date: May 30, 2024

(54) MANAGEMENT OF AN ASYNCHRONOUS MULTIPLAYER GAMBLING GAME

(71) Applicant: FENNICA GAMING OY, Helsinki (FI)

(72) Inventor: Kimmo KOSKINEN, Espoo (FI)

(21) Appl. No.: 18/495,190

(22) Filed: Oct. 26, 2023

(30) Foreign Application Priority Data
Nov. 25, 2022 (FI) 20226050

(51) Int. Cl. G07F 17/32

(52) U.S. Cl. CPC G07F 17/3225

(57) ABSTRACT

A computer implemented method for managing an asynchronous multiplayer gambling game is provided, the method comprising: assigning a randomized data array defining a result of a gaming session to a gaming session of the asynchronous multiplayer gambling game; executing the gaming session of the asynchronous multiplayer gambling game with respect to a player; and generating a message to the respective player, the message comprising information on the result of the gaming session in accordance with data defined in the randomized data array with respect to the player. Also a server, a computer program, and a system are provided to.

### TECHNICAL FIELD

The invention concerns in general the technical field of asynchronous multiplayer gambling games.

### BACKGROUND

The development of computing power and communication technologies has enabled an execution of computer-implemented multiplayer games between a plurality of players in a manner that closely resembles a face-to-face gaming session between the players. However, one challenge in the computer-implemented multiplayer games is to gather the plurality of players in the gaming session at the same time in order to provide the shared user experience in an appropriate way. Because this has turned out to be difficult there is developed solutions in which the players are playing the games asynchronously. An example of such an approach is described in a patent document US 2016/0260290 A1 in which a solution for facilitating an asynchronous group play of an online casino game is disclosed. In the cited document it is disclosed a solution how players' individual gambling outcomes are combined into a group outcome and matched with respect to the host of the casino game.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An object of the invention is to present a computer implemented method, a server, a computer program, and a system for executing an asynchronous multiplayer gambling game.

The objects of the invention are reached by a computer implemented method, a server, a computer program, and a system for executing an asynchronous multiplayer gambling game as defined by the respective independent claims.

According to a first aspect, a computer implemented method for managing an asynchronous multiplayer gambling game is provided, wherein at least two players access to a gaming session asynchronously, the method comprising:
assigning a randomized data array to a gaming session of the asynchronous multiplayer gambling game, the randomized data array at least defining a result of the gaming session with respect to each player in terms of a maximum number of players allowed to access the gaming session of the asynchronous multiplayer gambling game,
executing the gaming session of the asynchronous multiplayer gambling game with respect to a player accessing the gaming session of the asynchronous multiplayer gambling game until a number of players accessing the gaming session reaches the maximum number of players allowed to access the gaming session, the execution of the gaming session with respect to each player comprises an assignment of a game entity and a determination of the result of the gaming session with respect to the player based on the randomized data array, generating, in response to completing the gaming session with respect to the player, a message to the respective player, the message comprising information on the result of the gaming session in accordance with data defined in the randomized data array with respect to the player.

A generation of the randomized data array may e.g. be performed in response to one of the following: a detection of a first player allowed to access to the gaming session of the asynchronous multiplayer gambling game; setting up a depleting pool of data arrays for the asynchronous multiplayer gambling game applicable in a plurality of gaming sessions of the asynchronous multiplayer gambling game.

Moreover, the player may randomly be assigned to a gaming session among a plurality of gaming sessions.

The player may also be requested to select the game entity for the gaming session. For example, the game entity may be linked to a value in the randomized data array defining a result of the gaming session.

The randomized data arrow may be associated with metadata descriptive of events occurring during the gaming session of the asynchronous multiplayer gambling game. The metadata descriptive of events occurring during the gaming session may be defined based on a random value used for determining the events occurring during the gaming session in a deterministic manner. Further, the events occurring during the gaming session may be output to each player by controlling an output of a terminal device of each player.

According to a second aspect, a server for managing an asynchronous multiplayer gambling game is provided, wherein at least two players access to a gaming session asynchronously, the server is configured to:
assign a randomized data array to a gaming session of the asynchronous multiplayer gambling game, the randomized data array at least defining a result of the gaming session with respect to each player in terms of a maximum number of players allowed to access the gaming session of the asynchronous multiplayer gambling game,
execute the gaming session of the asynchronous multiplayer gambling game with respect to a player accessing the gaming session of the asynchronous multiplayer gambling game until a number of players accessing the gaming session reaches the maximum number of players allowed to access the gaming session, the execution of the gaming session with respect to each player comprises an assignment of a game entity and a determination of the result of the gaming session with respect to the player based on the randomized data array,
generate, in response to completing the gaming session with respect to the player, a message to the respective player, the message comprising information on the result of the gaming session in accordance with data defined in the randomized data array with respect to the player.

The server may e.g. be configured to perform a generation of the randomized data array in response to one of the following: a detection of a first player allowed to access to the gaming session of the asynchronous multiplayer gambling game; setting up a depleting pool of data arrays for the asynchronous multiplayer gambling game applicable in a plurality of gaming sessions of the asynchronous multiplayer gambling game.

The server may be configured to randomly assign the player to a gaming session among a plurality of gaming sessions.

Moreover, the server may be configured to request the player to select the game entity for the gaming session. The server may e.g. be configured to link the game entity to a value in the randomized data array defining a result of the gaming session.

Still further, the server may be configured to associate the randomized data arrow with metadata descriptive of events occurring during the gaming session of the asynchronous multiplayer gambling game. The metadata descriptive of events occurring during the gaming session may be defined based on a random value used for determining the events occurring during the gaming session in a deterministic manner. For example, the server may be configured to output events occurring during the gaming session to each player by controlling an output of a terminal device of each player.

For example, the server may be implemented as one of: a standalone apparatus; a distributed computing environment with a plurality of apparatuses.

According to a third aspect, a computer program is provided, the computer program comprises instructions which, when the computer program is executed by a computer, cause the computer to carry out the steps of the method according to the first aspect as defined above.

According to a fourth aspect, a gambling game system is provided, the gambling game system comprising:
a plurality of terminal devices for accessing to an asynchronous multiplayer gambling game, and
a server according to the second aspect as defined above.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF DRAWINGS

The embodiments of the invention are illustrated by way of example, and not by way of limitation, in the figures of the accompanying drawings.

FIG. 1 illustrates schematically an asynchronous multiplayer gambling game system according to an example.

FIG. 2 illustrates schematically an asynchronous multiplayer gambling game system according to another example.

FIG. 3 illustrates schematically a gaming server according to an example.

FIG. 4 illustrates schematically a method according to an example.

FIG. 5 illustrates schematically a data array according to an example.

FIG. 6 illustrates schematically a data array according to another example.

### DETAILED DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

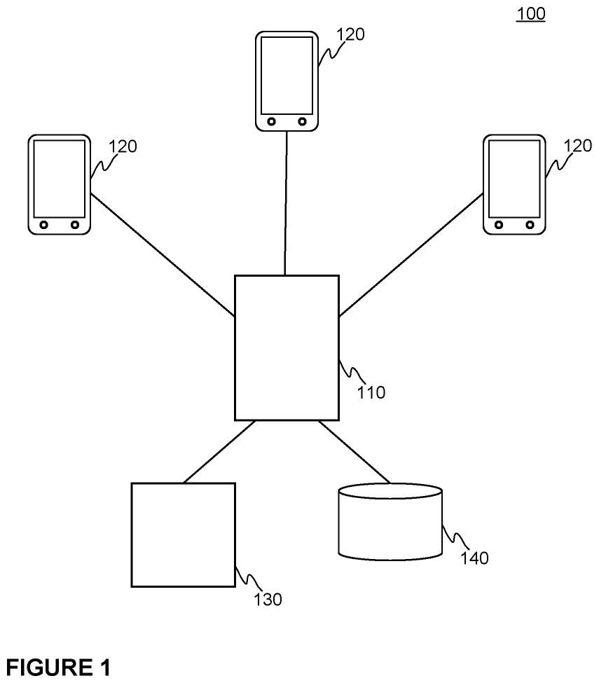

FIG. 1 illustrates schematically an example embodiment of an asynchronous multiplayer gambling game system 100. In accordance with the example embodiment the system 100 comprises a server 110 configured to execute operations causing running of one or more gambling games in the server 110. The running of the gambling game in the server 110 at least refers to a hosting of a number of terminal devices 120 in an asynchronous manner in order to enable users, i.e. players, of the terminal devices 120 to participate to the gambling game. An access to participate to the asynchronous multiplayer gambling game hosted by the server 110 may be established to the terminal devices 120 over a communication network, such as Internet. The communication connections between communicating entities may be established by applying wireless or wired communication technologies, or any combination of these.

In addition to the above described operations the server 110 may be configured to perform further operations with respect to the execution of the asynchronous multiplayer gambling game in the server 110, such as determining a result of a gaming session through a lottery operation. Moreover, the server 110 may be configured to perform further operations e.g. in relation to gaming session, such as executing further operations allowing one or more players in the gaming session to participate further gambling operations.

In some example embodiments the system 100 may be implemented so that the server 110 is arranged to execute the asynchronous multiplayer gambling game, but another server 130, e.g. called as a lottery generator server, may be arranged to execute an engine for generating lottery items applied in the asynchronous multiplayer gambling game for determining rankings between the players. The engine may be configured to generate random values which are then applied in the determination of the rankings between the players. The lottery generator server 130 may then generate one or more data arrays e.g. determining a result of the respective game in a manner as is described in forthcoming description.

In accordance with some example embodiments the system 100 may further comprise one or more data storages 140 e.g. implementing a database into which the server 110 may store various type of data related to the asynchronous multiplayer gambling game. The data storage 140 may also be configured to store user profiles of the players if such are enabled to be created and maintained in the data storage. The user profiles may also comprise data defining a monetary value for a number of the players available to be used in a context of the asynchronous multiplayer gambling game. Still further, the one or more data storages 140 may also serve other servers, such as the lottery generator server 130, by allowing storing of data.

The term ‘terminal device’ 120 shall be understood in a broad manner and covering any device enabling a participation to the gaming session. This may require a communication capability of the terminal devices 120 with the server 110 but also a capability to receive an input from a user as well as a capability to output data to the user, i.e. to the player. The execution of the gambling game in the terminal device 120 may require an installation of an application in the terminal device 120, for example. The terminal device may, for example, include laptop computers, handheld computers, personal computers, phones, gaming devices, game consoles, electronic gambling machine (EGM), and so on.

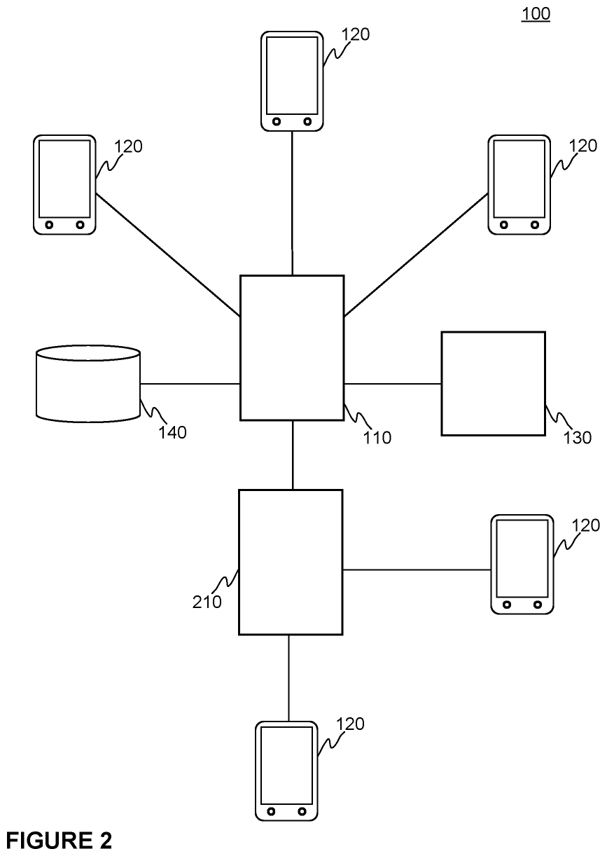

Furthermore, in some example embodiments the system 100 as shown in FIG. 1 may comprise an implementation in which at least some of the terminal devices 120 participating to the gaming session are connectable to the gaming server 110 over another server 210 hosting at least some of the terminal devices 120 as shown in FIG. 2. Such a server 210 may e.g. reside in a casino house into which a number of terminal devices 120 are arranged to play the asynchronous multiplayer gambling game.

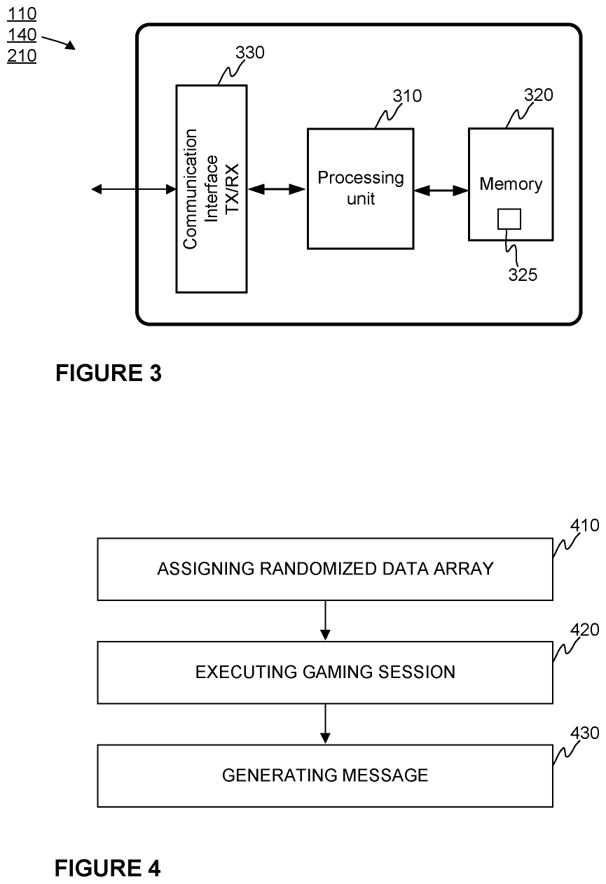

An example of the server 110, i.e. the gaming server, is schematically illustrated in FIG. 3. The apparatus implanting functionalities of the server 110 may be a computer device, for example. In other words, the apparatus of FIG. 3 may be configured to perform operations as is described in the forthcoming description. For sake of clarity, it is worthwhile to mention that the block diagram of FIG. 3 depicts some components of an entity that may be employed to implement a functionality of the apparatus.

The apparatus of FIG. 3 comprises a processor 310 and a memory 320. The memory 320 may store data, but also computer program code 325 causing a management of the asynchronous multiplayer gambling game in a manner as is described in the forthcoming description. The apparatus may further comprise a communication interface 330, such as a wireless communication interface or a communication interface for wired communication, or both to communicate with other entities. The communication interface 330 may thus comprise one or more modems, antennas, and any other hardware and software for enabling an execution of the communication e.g. under control of the processor 310. Furthermore, I/O (input/output) components may be arranged, together with the processor 310 and a portion of the computer program code 325, to provide a user interface for receiving input from a user and/or providing output to the user of the apparatus when necessary.

In particular, the user I/O components may include user input means, such as one or more keys or buttons, a keyboard, a touchscreen, or a touchpad, etc. The user I/O components may include output means, such as a loudspeaker, a display, or a touchscreen. The components of the apparatus may be communicatively connected to each other via data bus that enables transfer of data and control information between the components.

The memory 320 and at least a portion of the computer program code 325 stored therein may further be arranged, with the processor 310, to cause the apparatus to perform at least a portion of a method as is described in the forthcoming description. The processor 310 may be configured to read from and write to the memory 320. Although the processor 310 is depicted as a respective single component, it may be implemented as respective one or more separate processing components. Similarly, although the memory 320 is depicted as a respective single component, it may be implemented as respective one or more separate components, some, or all of which may be integrated/removable and/or may provide permanent/semipermanent/dynamic/cached storage.

The computer program code 325 may comprise computer-executable instructions that implement functions that correspond to steps implemented in the method when loaded into the processor 310 of the respective server 110. As an example, the computer program code 325 may include a computer program consisting of one or more sequences of one or more instructions. The processor 310 is able to load and execute the computer program by reading the one or more sequences of one or more instructions included therein from the memory 320. The one or more sequences of one or more instructions may be configured to, when executed by the processor 310, cause the apparatus to perform a method as described. Hence, the apparatus may comprise at least one processor 310 and at least one memory 320 including the computer program code 325 for one or more programs, the at least one memory 320 and the computer program code 325 configured to, with the at least one processor 310, cause the apparatus implementing the server 110 to perform the method.

The computer program code 325 may be provided e.g. a computer program product comprising at least one computer-readable non-transitory medium having the computer program code 325 stored thereon, which computer pro-gram code 325, when executed by the processor 310, causes the apparatus to perform the method. The computer-readable non-transitory medium may comprise a memory device or a record medium, such as a CD-ROM, a DVD, a Blu-ray disc, or another article of manufacture that tangibly embodies the computer program. As another example, the computer program may be pro-vided as a signal configured to reliably transfer the computer program.

Still further, the computer program code 325 may comprise a proprietary application, such as computer program code for causing an execution of the method in the manner as described in the description herein.

Any of the programmed functions mentioned may also be performed in firmware or hardware adapted to or programmed to perform the necessary tasks.

For sake of completeness it is worthwhile to mention that the other servers 130 and 210 may resemble the structure of the server 110 as shown in FIG. 3. Naturally, at least the computer program code 325 executed in the other servers differ from the one executed in the gaming server 110.

The operation of the server 110, as well as the other servers 130, 210, may be implemented with a plurality of apparatuses, such as with the one schematically illustrated in FIG. 3, as a distributed computing environment. The distributed computing environment may be implemented as a cloud computing system wherein a number of apparatuses are harnessed to execute operations to generate an implementation of a method as is described herein.

Next, aspects in relation to an execution of the asynchronous multiplayer gambling game are provided by referring to FIG. 4 schematically illustrating at least some steps of a computer implemented method wherein the server 110 may be arranged to perform the method at least in part. The player may use her/his terminal device 120 for accessing the asynchronous multiplayer gambling game. For example, the player may use an application installed in the terminal device 120 to communicatively connect to the server 110. The connection to the server 110 may require a provision of access credentials, such as a username and a password. After a successful logging procedure the player may be provided with an access to the gaming environment hosted by a gambling game provider and the player may e.g. select a game, she/he is willing to play. In accordance with the present invention the game selected is such that it allows the players to play the game asynchronously, i.e. that at least two players initiate playing of the game at different instants of time. Moreover, an access to the selected asynchronous multiplayer gambling game may require further operations, such as a transfer of a monetary value from the respective player to the gambling game provider. The monetary value may correspond to a money in real-world or crypto-currency as non-limiting examples.

For sake of completeness it is worthwhile to mention that the asynchronous multiplayer gambling game may vary in type. For example, it may be some sort of ball game, such as a marble, a sport game, such as an archery or car race competition, or any similar game allowing a meaningful asynchronous gaming between the players of the game.

In response to an accomplishment of required operations to access the asynchronous multiplayer gambling game a gaming session is initiated by the gaming server 110 for the player in question. For sake of clarity it is also worthwhile to mention that the gaming server 110 may maintain a plurality of gaming sessions simultaneously to each other. Thus, in response to that the player in question is allowed to access the game she/he may be directed to one of the gaming sessions maintained by the server 110 e.g. automatically or the user may be provided a possibility to select the gaming session among available gaming sessions.

In accordance with the present invention a data array comprising data defining a result of a gaming session is assigned 410 to the respective gaming session into which the player is directed. Depending on the implementation the data array may be obtained from a pool of data arrays generated for the asynchronous multiplayer gambling game (cf. depleting pool of data arrays) or a generation of the data array may be triggered based on at least one predefined condition, such as a first player is allocated to the gaming session (cf. non-depleting pool of data arrays). In case the depleting pool approach is applied to the generation of data arrays may be implemented so that the number of the drawn data arrays is large and available for the plurality of gaming sessions executed by at least the server 110. The draw of the data arrays may be performed by the server 110 or it may request the generation of the data arrays from another entity, such as from the lottery generator server 130 configured to execute a generator engine. The number of data arrays belonging to a same set of data arrays, i.e. to the pool of the data arrays, may e.g. be 100000-500000 pieces, but the number of them may depend on the game and other attributes.

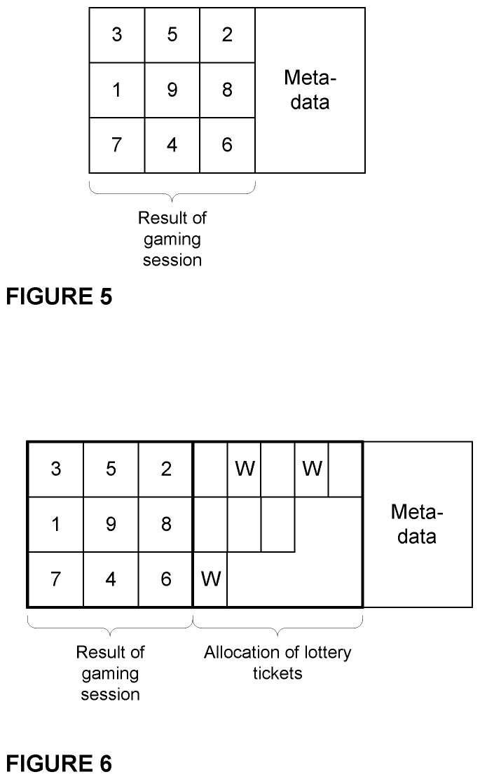

FIG. 5 illustrates schematically an example of a data array generated for a gaming session into which altogether nine players may access asynchronously. The predetermined result for each player in accordance with the embodiment shown in FIG. 5 is randomized, i.e. the ranking of each player in the gaming session is drawn and defined in the randomized data array. Thus, the player allowed to access the gaming session is linked to one of the data values defined in the randomized data array which defines the result of the game of the player. The further players accessing the same gaming sessions are also provided with the ranking in the game in the same manner from the remaining rank values, or result values, not used. Thus, the gaming session may be maintained accessible until there is nonused rankings in the data array. For sake of clarity it is worthwhile to mention that the data array shown in FIG. 5 is a non-limiting example and size of the data array, i.e. the number of data items defining the result of the game, may be adjusted in accordance with a maximum number of players allowed to play the game in question.

The description in relation to the data array refers to an arrangement that the data array defines the result for each player accessing to the gaming session. The result of the gaming session with respect to each player may also be implemented indirectly by arranging that the result is defined for each game entity used in the gaming session by the players. In other words, the values in the data array are provided for each game entity used by the players in the gaming session and, thus, the players are linked with the result of the gaming session over the game entities. As is described in the forthcoming description the method of assigning the game entities to different players may vary, and e.g. be arranged to be player selectable as a nonlimiting example of the allocation.

Moreover, the data array may comprise so-called metadata which in accordance with the present invention may define at least in some manner a number of events occurring in the gaming session. In other words, the metadata may comprise data which defines events in relation to the gaming session which are output to the different players accessing the gaming session asynchronously, and in such a manner a similar game experience during the game may be generated. For example, the metadata may comprise a seed random number based on which at least visual events may be deterministically calculated by applying the same algorithm for each players. In other word, independently of an order to play the game each user experience the same events in the game. The utilization of the seed random number as a ground for the events in the game enables an execution of complex chain of events in the gaming session, because an amount of metadata defining the events in the gaming session is minimized and, therefore, there is no need for an allocation of enormous amount of memory capacity to the game. Alternatively or in addition, the metadata may comprise a plurality of data parameters defining at least some aspects of the game.

The above described measures are related to a determination of result of the game but the gaming session from a point of a player may comprise, in response to accessing the gaming session, that the player is prompted to select a game entity over the user interface executed towards the player. The game entity herein e.g. refers to a virtual entity which is utilized in the game. Such an approach may increase an attraction of the player in the gaming session because she/he is provided with an impression to be capable of influencing a progress of the game. The game entity may e.g. be a marble in a marble game and the player may be prompted to select between marbles with different characteristics, such as a color of the marble or any other visual effect differentiating the marbles, or any other game entity, from each other.

The asynchronous nature of the game, but also the execution of the game in the above described manner, also allows to provide, for selection, all the game entities to all players. Namely, if a subsequent player to one or more earlier players selects the game entity with the same characteristics as any previous player the game experience may visually be arranged so that the game entity of the previous player who already has played the game is computationally changed to any other game entity with different characteristics so that the pending player may use the desired game entity. So, the player currently playing the game receives a game experience in which any previous players are playing with another game entity than she/he even if actually the previous player in question have played her/his game with the game entity having the same characteristics. Such a feature may be implemented but in some other embodiments it may be arranged that the player is only allowed to select between those game entities not yet used in the gaming session. For sake of completeness it is worthwhile to mention that the gaming session may also be implemented so that the user is not allowed to select the game entity, but it is automatically assigned to the player at an instant of the gaming session. The allowability to perform the selection may e.g. be dependent on a type of the game and how it is played to. In any case, the server 110 is configured to maintain the information on the assigned game entity per player, perform a visualization of the game entity in the game and utilize the game entity in the execution of the game per player in accordance with the calculation of events in the game for the player in question.

The assignment of the game entity to different players has also a security aspect and it may be used to prevent so-called collusion of different players to reach wins as a team in the gaming session. Namely, the approach in which the player is randomly assigned the game entity, even if he/she is allowed to select the color, or other characteristics with respect to the game entity, improves the security because the players trying to execute the collusion are not aware of the actual game entities with respect to each other even if they may see the events occurring in the gaming session. In other words, the characteristics visualized to a first player may differ from the characteristics of the game entity shown to others in the gaming session which makes the collusion more challenging. The security may also be improved by randomly allocating the players to different gaming sessions and e.g. utilizing there e.g. position information of each player if such information is available. Hence, in case the number of separate gaming sessions is high, the probability that two players knowing each other end up to the same gaming session is low. Hence, the collusion may again be prevented, or at least minimized. The technical solutions to implement the above given approaches may be implemented computationally e.g. so that the game entities are managed by the operator with hidden identities whereas the characteristics of the game entities are accessible by the players. In this manner the operator of the gaming session, and the game, may manage the characteristics visualized to others compared to the player himself/herself.

Thus, in response the above described operations the server 110 may start executing 420 the gaming session of the asynchronous multiplayer gambling game with respect to the player accessed the gaming session of the asynchronous multiplayer gambling game. The server 110 may be arranged to execute the gaming session until the number of players accessing the gaming session reaches the maximum number of players allowed to access the gaming session. As mentioned, the maximum number of players may e.g. be dependent on the type of the game, or any other criteria. In other words, the server 110 configured to perform the execution of the gaming session with respect to each player is configured at least to perform an assignment of a game entity, e.g. based on the player selection, and a determination of the result of the gaming session with respect to the player based on the randomized data array defining the result of the game. The result may be defined directly per player of indirectly over the game entity, as described. Naturally, the server 110 may also, during the execution of the gaming session, provide a visualization of a number of events occurring during the gaming session to the player in question. The execution of the gaming session by the server 110 comprises a communication with the terminal device 120 of the player but also with other entities depending on the implementation of the execution of the gaming session.

In response to a completion of the gaming session with respect to the player in question the server 110 is configured to generate 430 a message to the respective player wherein the message comprises information on the result of the gaming session in accordance with data defined in the randomized data array with respect to the game entity assigned to the player. The generation 430 of the message shall be understood in a broad manner and it may e.g. comprise that such piece of information is output to the player under the gaming session e.g. with a game application over which the gaming session is conducted. Alternatively or in addition, it may be arranged so that the message is generated over another messaging method, such as by applying any messaging application installed in the terminal device 120 of the player. For example, the player may have defined one or more preferred ways of receiving the message in order to receive the information. For example, the player may have indicated to receive the information by an email, by a short message service (SMS), by a service utilizing data network in a transmission of the messages, by a social-media application, etc.

In accordance with the invention due to the nature of the gaming session, i.e. at least some of the players are playing in the game asynchronously the asynchronous multiplayer gambling game may be configured to generate notifications to the players who have already played their game. The notifications may relate to the progress of the gaming session, i.e. to later events in the game. A non-limiting example of the notification may e.g. be that it comprises data informing that a certain data entity, such as a green marble, has won the game the recipient of the notification played one hour ago. Again, the notifications may be sent as messages using the same communication channels as described above in the context of informing the player on the result of the gaming session.

As regards to prizes of the gaming session various approaches may be established. First of all, the prize distribution is defined, i.e. how many players are provided with the win. Additionally, an amount of the prize, or prizes, are defined. For example, the prize money between the players, e.g. the highest ranked players, may be fixed and shown to players. In some other implementation the prizing scheme may be made visually attractive in the gaming session, e.g. in a manner that each player is assigned with a lottery ticket upon entry to the gaming session of the asynchronous multiplayer gambling game, e.g. through paying an entry fee. Only some of the lottery tickets are associated with a win. Each player may be prompted to allocate her/his lottery ticket to one winning box among a plurality of boxes and upon the allocation the gaming session is processed. Even if the player is prompted to allocate the lottery ticket to one winning box, the lottery tickets are actually already allocated to different winning boxes. In other words, the result of the prizing, through the winning boxes, may also be decided independently of the player selection. The data on the result of the prizing may be included in the data array e.g. in a manner as shown in FIG. 6. The allocation of the lottery tickets in a prize distribution in which three players are provided with win may be implemented so that the winner receives five lottery tickets, the second receives three lottery tickets and the third receives one lottery ticket. Due to fact, that the allocation of the lottery tickets between the winning boxes (each row of the allocated lottery tickets correspond to one winning box) is random, it may occur that a lower ranked player receives more prize e.g. in terms of money than a higher ranked player. This may be implemented due to the asynchronous nature of the gambling game and due that the result of the game and/or the winning distribution is hidden from the players. Naturally, e.g. a total amount of prize money may be informed and naturally the winner(s) receive(s) information on their/her/his share(s) of the prize money. The above described way of arranging the prizing scheme with the lottery tickets is a non-limiting example and alternative ways to arrange the same may be introduced in addition to the fixed prizing scheme.

The specific examples provided in the description given above should not be construed as limiting the applicability and/or the interpretation of the appended claims. Lists and groups of examples provided in the description given above are not exhaustive unless otherwise explicitly stated.

What is claimed is:

1. A computer implemented method for managing an asynchronous multiplayer gambling game, wherein at least two players access to a gaming session asynchronously, the method comprising:
assigning a randomized data array to the gaming session of the asynchronous multiplayer gambling game, the randomized data array at least defining a result of the gaming session with respect to each player in terms of a maximum number of players allowed to access the gaming session of the asynchronous multiplayer gambling game,
executing the gaming session of the asynchronous multiplayer gambling game with respect to a player accessing the gaming session of the asynchronous multiplayer gambling game until a number of players accessing the gaming session reaches the maximum number of players allowed to access the gaming session, the execution of the gaming session with respect to each player comprises an assignment of a game entity and a determination of the result of the gaming session with respect to the player based on the randomized data array,
generating, in response to completing the gaming session with respect to the player, a message to the player, the message comprising information on the result of the gaming session in accordance with data defined in the randomized data array with respect to the player.

2. The method according to claim 1, wherein a generation of the randomized data array is performed in response to one of: a detection of a first player allowed to access to the gaming session of the asynchronous multiplayer gambling game; setting up a depleting pool of data arrays for the asynchronous multiplayer gambling game applicable in a plurality of gaming sessions of the asynchronous multiplayer gambling game.

3. The method according to claim 1, wherein the player is randomly assigned to the gaming session among a plurality of gaming sessions.

4. The method according to claim 1, wherein the player is requested to select the game entity for the gaming session.

5. The method according to claim 4, wherein the game entity is linked to a value in the randomized data array defining the result of the gaming session.

6. The method according to claim 1, wherein the randomized data array is associated with metadata descriptive of events occurring during the gaming session of the asynchronous multiplayer gambling game.

7. The method according to claim 6, wherein the metadata descriptive of events occurring during the gaming session is defined based on a random value used for determining the events occurring during the gaming session in a deterministic manner.

8. The method according to claim 7, wherein the events occurring during the gaming session are output to each player by controlling an output of a terminal device of each player.

9. A server for managing an asynchronous multiplayer gambling game, wherein at least two players access to a gaming session asynchronously, the server is configured to:
assign a randomized data array to the gaming session of the asynchronous multiplayer gambling game, the randomized data array at least defining a result of the gaming session with respect to each player in terms of a maximum number of players allowed to access the gaming session of the asynchronous multiplayer gambling game,
execute the gaming session of the asynchronous multiplayer gambling game with respect to a player accessing the gaming session of the asynchronous multiplayer gambling game until a number of players accessing the gaming session reaches the maximum number of players allowed to access the gaming session, the execution of the gaming session with respect to each player comprises an assignment of a game entity and a determination of the result of the gaming session with respect to the player based on the randomized data array,
generate, in response to completing the gaming session with respect to the player, a message to the respective player, the message comprising information on the result of the gaming session in accordance with data defined in the randomized data array with respect to the player.

10. The server according to claim 9, wherein the server is configured to perform a generation of the randomized data array in response to one of: a detection of a first player allowed to access to the gaming session of the asynchronous multiplayer gambling game; setting up a depleting pool of data arrays for the asynchronous multiplayer gambling game applicable in a plurality of gaming sessions of the asynchronous multiplayer gambling game.

11. The server according to claim 9, wherein the server is configured to randomly assign the player to the gaming session among a plurality of gaming sessions.

12. The server according to claim 9, wherein the server is configured to request the player to select the game entity for the gaming session.

13. The server according to claim 12, wherein the server is configured to link the game entity to a value in the randomized data array defining the result of the gaming session.

14. The server according to claim 9, wherein the server is configured to associate the randomized data array with metadata descriptive of events occurring during the gaming session of the asynchronous multiplayer gambling game.

15. The server according to claim 14, wherein the metadata descriptive of events occurring during the gaming session is defined based on a random value used for determining the events occurring during the gaming session in a deterministic manner.

16. The server according to claim 15, wherein the server is configured to output events occurring during the gaming session to each player by controlling an output of a terminal device of each player.

17. The server according to claim 9, wherein the server is implemented as one of: a standalone apparatus; a distributed computing environment with a plurality of apparatuses.

18. A computer program product comprising at least one non-transitory computer-readable storage medium having computer-executable program code instructions stored therein, the computer-executable program code instructions being configured, when the computer-executable program code instructions are executed on a computer, to cause the computer to at least:
assign a randomized data array to a gaming session of an asynchronous multiplayer gambling game, the randomized data array at least defining a result of the gaming session with respect to each player in terms of a maximum number of players allowed to access the gaming session of the asynchronous multiplayer gambling game,
execute the gaming session of the asynchronous multiplayer gambling game with respect to a player accessing the gaming session of the asynchronous multiplayer gambling game until a number of players accessing the gaming session reaches the maximum number of players allowed to access the gaming session, the execution of the gaming session with respect to each player comprises an assignment of a game entity and a determination of the result of the gaming session with respect to the player based on the randomized data array,
generate, in response to completing the gaming session with respect to the player, a message to the respective player, the message comprising information on the result of the gaming session in accordance with data defined in the randomized data array with respect to the player.

19. A gambling game system comprising:
a plurality of terminal devices for accessing to an asynchronous multiplayer gambling game, and
the server according to claim 9.
